(19) United States
(12) Patent Application Publication
(10) Pub. No.: US 2026/0151951 A1
(43) Pub. Date: Jun. 4, 2026

(54) A METHOD AND APPARATUS FOR PRODUCING DISPENSING SQUEEZE CONTAINERS

(71) Applicant: CREATIVE PROPACK LTD., Mumbai, Maharashtra (IN)

(72) Inventor: Hersh Agarwal, Mumbai (IN)

(21) Appl. No.: 19/126,395

(22) PCT Filed: Oct. 25, 2023
(86) PCT No.: PCT/IN2023/050980

§ 371 Date: May 1, 2025

(30) Foreign Application Priority Data
Nov. 3, 2022 (IN) 202221062829

(51) Int. Cl. B29C 49/06; B29C 49/70; B29L 31/00

(52) U.S. Cl. CPC B29C 49/063; B29C 49/70; B29C 2049/701; B29C 2949/0715; B29L 2031/712

(57) ABSTRACT

The present invention discloses a dispensing squeeze tube container and a method of forming the same. The method includes steps of forming an open ended preform by injection molding; blowing a compressed air into the open ended perform to form the squeeze tube with neck finish; and ejecting the finished product. The present invention further discloses an apparatus adapted to produce dispensing squeeze tube container by injection blow molding technique.

### FIELD OF INVENTION

The present invention generally relates to a process of manufacturing of polymer tubes. More particularly, the present invention relates to producing dispensing squeeze tubes made of plastic materials by Injection Blow Molding process.

### BACKGROUND & PRIOR ART

A dispensing squeeze tube is a container to dispense viscous liquid. The viscous liquid may be toothpaste, medicinal gel, a liquefied colour and such elements, and may be dispensed by applying pressure from the bottom side of the tube. Generally, the squeeze tube is hollow cylindrical container roughly having a rectangular shape with finished neck that dispenses the viscous liquid on application of pressure. The body of the squeeze tube is generally made of plastic or metal. In older times, the squeeze tubes were almost exclusively made of metal body, which has been replaced by the plastic material in modern times. The squeeze tube may be collapsible one, wherein the tube is deformed after each squeezing. However, some squeeze tubes retain its shape even after squeezing.

The squeeze tubes are traditionally manufactured by extrusion process, wherein the material is melted and extruded into the mold. The Injection Blow Molding (IBM) process is commonly employed for manufacturing plastic bottles, wherein the IBM primarily involves melting the plastic and subsequently injecting into a mold, which is made according to the requirement of making the bottle. Another advantage of the IBM is a precise neck finish of the bottle as a final product.

In a typical IBM process, which is either three-step or four-step process, the first step involves forming a preform. The preform is external shape formed around mandrel, also known as core rod, which ultimately takes the desired shape of the bottle after blowing at the end of the process. The preform is conditioned, which depends upon the requirements of the design of the bottle in finished form. Further, the preform includes a fully formed neck, also called as threaded neck, with the body of thick polymer tube. If the IBM process is a three-step process, then the conditioning of the preform is done in the first step itself. If the IBM process is a four-step process, then the conditioning is done in the second step. The conditioned preform is then moved to second step/station where it is blown by compressed air, wherein the preform is inflated by the blown air to form the bottle. The bottles are finally ejected in the last ejection station after a certain cooling period. Since neck is formed in the first step/station by injection molding process, it is very precise. For the said reason, IBM process is commonly employed for the purpose of making plastic bottles with precise neck in any industry.

Globally, the IBM process is used for manufacturing of bottles and containers. However, IBM has never been employed for production dispensing squeeze tubes.

### SUMMARY OF INVENTION

It is a primary object of the present invention to produce the dispensing squeeze tubes using injection blow molding process.

Accordingly, the present invention discloses a method of forming a dispensing squeeze tube, wherein the method comprises the steps of: forming a preform with open end by injection molding; blowing the preform by compressed air to form the tube with neck; and ejecting the tube as final product.

In an embodiment, the open ended preform is formed by injection molding in the first step.

In an embodiment, the compressed air is blown to form the neck and tube in the second step.

It may be noted that the preform is formed with a neck finish in the known IBM process, whereas the open ended preform is formed in the present process with no neck. This implies that the neck finish is formed by injection molding in the known process. On the contrary, the neck finish is formed by blowing compressed air in the present process.

The present invention further discloses a mold apparatus which is adapted to produce the squeeze container by the injection blow molding process.

The present invention further discloses a dispensing squeeze container which is formed by Injection Blow Molding Technology.

### BRIEF DESCRIPTION OF DRAWINGS

The figures below show an exemplary embodiment:

FIG. 1 illustrates a known IBM process.

FIG. 2 illustrates the dispensing squeeze tube produced by the novel method of the present invention by Injection Blow Molding Technology.

FIG. 3 illustrates a schematic representation of a mold apparatus employed in the present process.

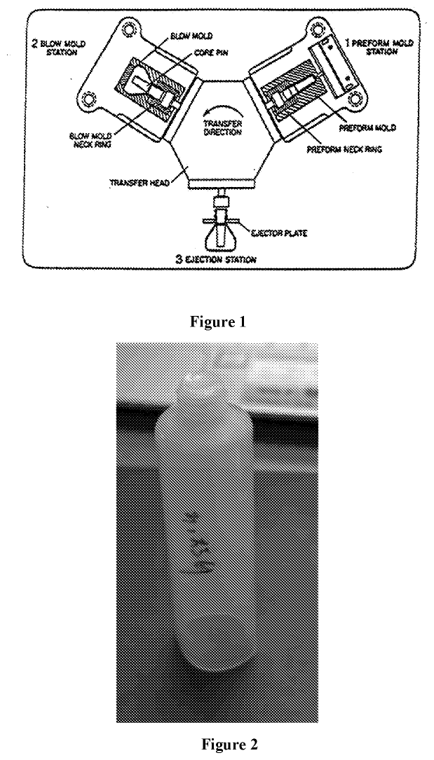

### DESCRIPTION OF INVENTION

The present invention discloses a process of forming a dispensing squeeze tube/container by the injection blow molding technique. The present invention further discloses an apparatus adapted to produce the dispensing squeeze tube/container by the injection blow molding technique.

For practical purposes, the description of known components or manufacturing processes are omitted in the above description to avoid any ambiguity that may arise while referring to specification. Further, certain terms and conditions have their usual meaning known to the person skilled in the art.

In the context of the present invention, “tube” may include any kind of a squeeze tube for the purposes that are applicable in various fields. “Neck finish” is the finished neck, usually in the form of threaded or plug fit neck, provided to the tube.

The present invention is comprehended with reference to accompanying figures, which describe the best embodiment as well as alternate embodiments of the invention. However, it may be noted that the figures demonstrate different embodiments and are not intended to restrict the scope of the invention.

In a preferred embodiment of the present invention, the present invention discloses a method of forming a tube by Injection Blow Molding technology. The method comprises of the steps of: forming a preform with open end; blowing the preform by compressed air to form the tube with neck; and ejecting the tube as final product.

In a preferred embodiment, the open ended preform is formed in the first step at the injection molding station. For the purpose of forming the open ended preform, molten polymer is injected onto a core rod, or mandrel as it is alternately called, in the preform mold. Consequently, the molten polymer is clamped around the core rod, forming the preform. It is to be noted that the neck insert is not employed in this stage, due to which the preform without neck finish is formed.

In the next stage of the preferred embodiment, the open ended preform is removed from the preform mold and rotated to the blow mold station. At the blow mold station, the neck mold is also brought into the process, wherein the compressed air is blown at a desired and controlled rate into the open ended preform. Hence at this stage, the tube with the neck finish is formed. The fully formed squeeze tube is ejected at the last station i.e. ejection station.

It may be noted that the preform is formed with a neck finish in the known IBM process in the first station of injection molding, whereas the open ended preform, without neck finish, is formed in the present process. This implies that the neck finish is formed by injection molding in the known process. On the contrary, the neck finish is formed by blowing compressed air in the present process in the second station of blow molding.

In a typical injection blow molding process, the perform with neck finish is formed around the core rod. As a result, the neck of the container has a diameter comparable to that of the body. The present method is configured to produce the tube with the neck having no hole, wherein the hole may be of any size which is significantly smaller diameter than the body.

It may be noted that the tube/container produced does not contain any hole in the neck of the tube. The hole may be drilled of any size depending upon the viscosity of the product to be dispensed.

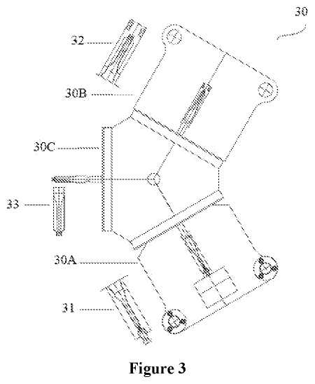

FIG. 3 illustrates an apparatus 30 employed for producing the dispensing squeeze container of the present invention. In a preferred embodiment, the apparatus may be a mold configured to achieve the objective of the present invention. The mold apparatus 30 includes a injection molding station 30A, provided with an open-ended preform unit 31 that assist in producing a neckless preform by injection molding. The open ended preform unit 31 is neckless unit and is adapted to produce injection molded preform without its neck. The apparatus further includes a blow station 30B, which is provided with a neck blow unit 32, wherein the compressed air is blown to the open-ended preform to form the blow molded squeeze container with the neck. The apparatus further includes a station 30C, provided with an ejection unit 33 wherein the squeeze container is ejected in a form of a final product.

The above description is merely illustrative, which is not intended to limit the scope of the invention to the described embodiment. The description covers alternatives, modifications of the embodiments described above. Number of alternatives, modification, changes, integration in terms of material used and method employed may be envisaged within the scope of the invention. The various features and advantages above are demonstrated with reference to the various embodiments in accordance with the present invention.

We claim:

1. A method of forming a dispensing squeeze container/tube comprising steps of:
forming an open ended preform by injection molding;
blowing a compressed air into the open ended preform along with a neck mold to form the tube with neck finish; and
ejecting the tube as final product with a neck and a body.

2. The method as claimed in claim 1, wherein the open ended preform is formed at an injection molding station without employing a neck mold.

3. The method as claimed in claim 1, wherein the neck finish has diameter less than that of the body.

4. An apparatus adapted to produce a dispensing squeeze container/tube comprises an injection station 30A provided with an open-ended preform unit 31; a blow station 30B provided with a neck blow unit 32; and a station 30C provided with an ejection unit 33.

5. A dispensing squeeze container/tube, wherein said dispensing squeeze container/tube is produced in steps comprises of: forming an open ended preform by injection molding; blowing a compressed air into the open ended preform along with a neck mold to form the tube with neck finish; and ejecting the tube as final product with a neck and a body.
